(19) United States
(12) Patent Application Publication
(10) Pub. No.: US 2010/0020746 A1
(43) Pub. Date: Jan. 28, 2010

(54) ADVERTISEMENT OF MULTIPLE SECURITY PROFILES IN WIRELESS LOCAL AREA NETWORKS

(75) Inventor: Artur Zaks, Modiin (IL)

Correspondence Address: TEXAS INSTRUMENTS INCORPORATED, P O BOX 655474, M/S 3999, DALLAS, TX, 75265, US

(73) Assignee: Texas Instruments Incorporated

(21) Appl. No.: 12/181,072

(22) Filed: Jul. 28, 2008

(51) Int. Cl. G06Q 30/00

(52) U.S. Cl. 370/328

(57) ABSTRACT

A novel and useful apparatus for and method of advertising multiple security profiles in wireless local area networks (WLANs). The security profile advertisement mechanism of the present invention advertises all configured security profiles by sending unsolicited 802.11 management probe response frames to the broadcast MAC address for available security profile. The access points sends these unsolicited probe response frames periodically, such as with the Beacon period. The conventional management application in the stations receives unsolicited advertisements of multiple SSIDs and perform a passive scanning process to obtain a list of BSSs available on the radio channel. The station can then display a list of all detected SSID advertisements to the user. The user of the station thus obtains information on all security profiles available on the access point without requiring any prior knowledge of specific SSIDs.

### FIELD OF THE INVENTION

The present invention relates to the field of data communications and more particularly relates to an apparatus for and method of advertising multiple security profiles in wireless local area networks (WLANs).

### BACKGROUND OF THE INVENTION

Currently, the trend of anytime an anywhere computing and communication is growing at an ever quicker pace. Wireless communication technology coupled with the available of light weight, powerful, compact and portable computing devices is largely responsible for this rapidly increasing trend. Strong market demand continues unabated for data and multimedia networking mobility. The IEEE802.11 based WLAN standards continue to offer consumers and businesses alike a viable high performance, cost effective, and easy to implement solution for networking mobility.

Throughput intensive applications, such as multimedia (streaming of high quality audio, Voice over Internet Protocol (VoIP) based telephony, and digital video), represent both today's highest demand for available wireless network bandwidth and fidelity and the area of greatest new growth. Unfortunately, these are also the first applications to feel the effects of the “weakest link” in the communications chain, the wireless link. These effects include reduction in range and degraded performance when compared to multimedia transfers using unshielded twisted pair (UTP), coaxial, and other forms of wired connection. In addition to the emergence and growth of high bandwidth applications is the propensity for WLANs to include greater numbers of users. Home, small office home office (SOHO), small business and enterprise class business WLAN users all attempt to maximize the number of users while minimizing the number of installed fixed access points (APs) or AP-types, e.g., home gateways, routers/firewalls, WLAN-equipped servers (such as server area network (SAN), set-top-boxes (STBs), network switches, video displays, etc.

A wireless local area network (WLAN) links two or more computers together without using wires. WLAN networks utilize spread-spectrum technology based on radio waves to enable communication between devices in a limited area, also known as the basic service set. This gives users the mobility to move around within a broad coverage area and still be connected to the network.

For the home user, wireless networking has become popular due to the ease of installation and location freedom with the large gain in popularity of laptops. For the business user, public businesses such as coffee shops or malls have begun to offer wireless access to their customers, whereas some are even provided as a free service. In addition, relatively large wireless network projects are being constructed in many major cities.

There are currently there exist several standards for WLANs: 802.11, 802.11a, 802.11b, 802.11g and 802.11n. The 802.11b has a rate of 11 Mbps in the 2.4 GHz band and implements direct sequence spread spectrum (DSSS) modulation. The 802.11a is capable of reaching 54 Mbps in the 5 GHz band. The 802.11g standard also has a rate of 54 Mbps but is compatible with 802.11b. The 802.11a/g implements orthogonal frequency division multiplexing (OFDM) modulation.

A wireless ad hoc network is a computer network in which the communication links are wireless, The network is termed ad hoc because each node is able to forward data for other nodes wherein the decision to which nodes forward data is made dynamically based on the particular network connectivity. This is in contrast to legacy network technology in which some designated nodes, usually comprising custom hardware and known as routers, switches, hubs and firewalls, perform the task of forwarding the data. Minimal configuration and quick deployment make ad hoc networks suitable for emergency situations like natural or human-induced disasters, military conflicts, emergency medical situations, etc.

A network diagram illustrating an example prior art WLAN network is shown in FIG. 1. The example network, generally referenced 10, comprises a WLAN access point 14 (AP) coupled to a wired LAN 22 such as an Ethernet network. The WLAN AP in combination with laptop 16, personal digital assistant (PDA) 18 and cell phone 20, form a basic service group (BSS) 12. A server 24, desktop computers 26, router 28 and Internet 30 (via router 32) are connected to the wired LAN 22.

A WLAN station or STA is any component that can connect into a wireless medium in a network. All stations are equipped with wireless network interface cards (NICs) and are either access points or clients. Access points (APs) are base stations for the wireless network. They transmit and receive radio frequencies for wireless enabled devices to communicate with. Wireless clients can be mobile devices such as laptops, personal digital assistants, IP phones or fixed devices such as desktops and workstations that are equipped with a wireless network interface card.

The basic service set (BSS) is defined as the set of all stations that can communicate with each other. There are two types of BSS: (1) independent BSS and (2) infrastructure BSS. Every BSS has an identification (ID) called the BSSID, which is the MAC address of the access point servicing the BSS. An independent basic service set (BSS) is an ad hoc network that contains no access points, which means the stations within the ad hoc network cannot connect to any other basic service set.

An infrastructure basic service set (BSS) can communicate with other stations that are not in the same basic service set by communicating through access points. An extended service set (ESS) is a set of connected BSSs. Access points in an ESS are connected by a distribution system. Each ESS has an ID called the SSID which is a 32-byte (maximum) character string. A distribution system connects access points in an extended service set. A distribution system is usually a wired LAN but can also be a wireless LAN.

The types of wireless LANs include peer to peer or ad hoc wireless LANs. A peer-to-peer (P2P) WLAN enables wireless devices to communicate directly with each other. Wireless devices within range of each other can discover and communicate directly without involving central access points. This method is typically used by two computers so that they can connect to each other to form a network. If a signal strength meter is used in this situation, it may not read the strength accurately and can be misleading, because it registers the strength of the strongest signal, which may be the closest computer.

A block diagram illustrating an example prior art WLAN access point in more detail is shown in FIG. 2. The WLAN AP, generally referenced 50, comprises an RF front end module (FEM) 60 coupled to antenna 62, PHY circuit 58, baseband processor/MAC 56, host 54, MAC memory 55, host memory 52, controller 64 and power management 66. The RF FEM comprises the RF switch, bandpass filter, bandpass filter and other RF front end circuitry (not shown). The PHY circuit comprises I and Q signal analog to digital converters (ADCs) and I and Q signal digital to analog converters (DACs) (not shown). MAC and host memories 52, 55 comprise any suitable memory devices such as EEPROM, static RAM, ROM, FLASH memory, other non-volatile memory (NVM), etc.

The RF front end circuit with the radio functions to filter and amplify RF signals and perform RF to IF conversion to generate I and Q data signals for the ADCs and DACs in the PHY. The baseband processor functions to modulate and demodulate I and Q data, perform carrier sensing, transmission and receiving of frames. The medium access controller (MAC) functions to control the communications (i.e. access) between the host device and applications. The power management circuit 66 is adapted to receive power via a wall adapter, battery or other power source.

The IEEE 802.11 standard provides for two modes of operation: an active mode and a power saving (PS) mode. Power saving (PS) mode is a power efficient method that prolongs the network operation time of battery powered wireless LAN devices. It is a synchronous protocol which requires precise time synchronization among all the participating stations within the Independent Basic Service Set (IBSS). Therefore, a Time Synchronization Function (TSF) is defined for the protocol to operate without the aid of external timing sources. The standard assumes the stations are time synchronized and thus all PS stations will wake up at about the same time.

Time synchronization is achieved by periodically transmitting a time synchronization beacon, which defines a series of fixed length beacon intervals. The successful beacon serves to synchronize the clocks of the stations in the network.

### WLAN Security Profiles

WiFi (or WLAN) Public Access is an infrastructure that is being installed in more and more public places. They are commonly known as WiFi “hot spots” and the allow visitors and other users that are equipped with WiFi enabled devices to access the Internet. WiFi Public Access is normally constructed of one or more Access Points connected to the Internet backbone.

The users of WiFi Public Access networks utilize connections to multiple networks as follows: (1) Hot Spot guest intranet which is a free of charge network with low security (e.g., airport flight information; (2) Hot Spot business intranet which is a free of charge network with high security (e.g., airport management network used by employees; and (3) Secured billed access to the Internet through one or more Wireless Internet Service Providers (WISPs).

Users of WiFi Public Access networks are connected to the infrastructure through an Access Point (AP) that matches the security profile of the user. A security profile is a mechanism or method used to achieve privacy over a WLAN connection. Examples of a security profile include: No Privacy, Fixed WEP, 802.1X Authentication with Dynamic WEP, WPA and WPA2. Note that Wired Equivalent Privacy (WEP) was included as the privacy of the original IEEE 802.11 standard ratified in September 1999. WEP uses the RC4 stream cipher for confidentiality and the CRC-32 checksum for integrity. It was deprecated as a wireless privacy mechanism in 2004, but for legacy purposes is still documented in the current standard. Wi-Fi Protected Access (WPA and WPA2) is a certification program administered by the Wi-Fi Alliance to indicate compliance with the security protocol created by the Wi-Fi Alliance to secure wireless computer networks. Data is encrypted using the RC4 stream cipher with a 128-bit key and a 48-bit initialization vector (IV). One major improvement in the protocol over WEP is the Temporal Key Integrity Protocol (TKIP), which dynamically changes keys as the system is used. When combined with the much larger initialization vector, this provides greatly improved protection against, and effectively defeats, the well-known key recovery attacks on WEP.

Normally, a connection from a STA to a specific network is maintained using a specific security profile. For example, an airport flight information network connection is provided using a No Privacy profile. In another example, access to the Internet through the WISP network is provided using a WPA2 security profile.

An Access Point (AP) can provide single or multiple security profiles, thus enhancing equipment reuse. An AP supporting a single security profile advertises it in Beacon and Probe Response messages, as defined in the WiFi WPA/WPA2 and IEEE 802.11i specifications. Such an AP maintains a single L2 network segment.

Access points normally advertise the security profile of the BSS in the 802.11 Beacon management frame. This is the mechanism used to advertise single security profiles. Multiple SSID features enable multiple security profiles at a single access point.

An AP supporting multiple security profiles maintains multiple L2 segments (i.e. VLANs), each corresponding to a specific profile. Such an AP must have a means to advertise the security profiles it supports. In order to obtain the specific security profile details, 802.11 stations need to be pre-configured with the SSID and perform 802.11 active scanning. This includes the station sending broadcast management frame probe request messages that contain the pre-configured SSID information. The station waits for the unicast probe response management frame sent from the access point containing the details of the security profile corresponding to the SSID. The problem, however, is that this mechanism does not permit the station to receive all possible security profiles supported by the particular access point.

Currently, the following multiple security profile implementation options exist:

1. Multiple SSID Option: This option associates a security profile with a WLAN Basic Service Set Identifier (SSID). It provides for multiple associations over a single LAN segment (BSSID) defined on a single WLAN MAC hardware entity (i.e. AP box).

2. Multiple BSSID option: This option associates a security profile with a WLAN Basic Service Set Identifier (BSSID). It provides multiple associations in a single AP box and is equivalent to having multiple virtual APs in single AP box.

The Multiple SSID implementation option performs multiple security profile advertisement in APs implemented with Multiple SSID capability. In this option, the advertisement of security profiles is achieved through Beacon advertisements. Every security profile is advertised in subsequent Beacon frames. A full advertisement cycle is completed after all the various security profiles are sent. Thus, for number N of security profiles, N Beacon frames are needed to complete the cycle.

A prior art example of a WLAN with multiple SSID deployment is shown in FIG. 3. The network, generally referenced 70, comprises an access point 74 in communication with a plurality of STAs 72. In this example, the network supports multiple SSIDs such as the two shown: “Guest” and “Employee”. The security for each SSID is different, i.e. WEP and WPA. The BSSID of each comprises the AP MAC address.

The benefits of this prior art scheme is its backward compatibility with existing stations. A disadvantage of this scheme, however, is its impact on station battery power consumption. Since Beacons are transmitted at the lowest PHY rate, the stations must be awake with their receivers switched on to receive all the Beacon frames. This results in significant battery power consumption.

Further, Quality of Service (QOS) of co-located Basic Service Set (BSS) is impacted since Beacons have the highest priority in air channel access. The transmission of multiple Beacon frames delays other traffic on the air channel and may lead to reduction of service quality.

Another security option is to hide SSIDs wherein one of the SSIDs is advertised in Beacon frames while the rest of the SSIDs are not advertised at all. Clients (i.e. STAs) must have knowledge of the SSID that the AP supports in order to request the security profile associated with that SSID. If they do not have knowledge of the SSID, STAs cannot retrieve the security profile and thus cannot communicate on networks with that SSID.

All the above mentioned prior art schemes are characterized by poor interoperability with existing clients. Under these schemes, clients do not detect all advertised SSIDs/security profiles.

The hidden SSID scheme has the best interoperability for Multiple SSID implementation. Major implementation disadvantages of this scheme include: (1) high protocol overhead in that STAs have to explicitly request information from the Access Point which leads to increased STA battery power consumption; and (2) having multiple broadcast keys, one broadcast key per SSID, wherein BSS broadcast traffic for a specific SSID will not be decrypted successfully by clients belonging to a different SSID of a given BSS, thus clients must not make any roaming decisions when encountering such BSS behavior. The benefit of this scheme, however, is its low cost of implementation which is able to be handled as a software upgrade.

The Multiple BSSID implementation option, described below provides a better interoperable solution since it does not preclude any knowledge of multiple security profiles on the part of the client. The main concern regarding the implementation of the Multiple BSSID option is that the AP impersonates the network node with multiple MAC addresses. Ramifications of this include: (1) replying to unicast packets or RTS frames targeted to one of the MAC addresses the Multiple BSSID AP impersonates with 802.11 ACKs/CTS frames; (2) power save buffering and broadcast packet handling per BSSID is required; and (3) the higher cost of implementation since lower MAC changes require costly modifications of the hardware.

A prior art example of a WLAN with multiple BSSID deployment is shown in FIG. 4. The network, generally referenced 80, comprises an access point 82 that implements two virtual APs, virtual AP 1 (84) and virtual AP 2 (86) having MAC addresses MAC1 and MAC2, respectively. Virtual AP 1 is in communication with a plurality of STAs 88 with “guest” SSID while virtual AP 2 is in communication with a plurality of STAs 89 with “Employee” SSID. The security for each SSID is different, i.e. WEP and WPA. The BSSID of virtual AP 1 is MAC1 while the BSSID of virtual AP 2 is MAC2.

The IEEE 802.11v Wireless Network Management specification under development defines a mechanism to advertise multiple security profiles including both SSID and BSSID advertisements.

In Multiple SSID advertisement, if the access point supports 802.11v and indicates Multiple SSID support in the Beacon frame, the STA sends a Multiple SSID Information Element (IE) in a Probe Request requesting security profile information for one or mode SSIDs.

A diagram illustrating the format of a prior art probe request multiple SSID information element is shown in FIG. 5. The multiple SSID information element, generally referenced 90, comprises a 1-byte element ID field 92, 1-byte length field 94 and a variable length SSID list field 96.

In this scheme, the Access Point receives the Probe Request message incorporating the Multiple SSID IE and responds with a Probe Response message containing security profile information. The security profile information is conveyed in a Robust Security Network (RSN) Information Element (IE) for one or more specific SSIDs.

The benefit of this scheme is that it provides an explicitly defined mechanism to request information for one or more specific security profiles. A major disadvantage of this scheme, however, is that it is not backward compatible with existing access points as it requires 802.11v capable access points to work. Further, the scheme requires more time from the STAs to discover specific security profiles due to the transmission of a frame sequence (i.e. the probe request messages and corresponding responses. This consumes additional battery power which is already limited and effects roaming time.

In Multiple BSSID advertisement, a single Beacon frame is sent rather than multiple Beacon frames (as in Multiple SSID advertisement) when the access point supports multiple BSSIDs (i.e. the “virtual AP” case). In this scheme a new information element is defined (Multiple BSSID IE), which is sent by the transmitted BSSID, that carries the common, inherited information element values of all of the BSSIDs and the unique information elements of the non-transmitted BSSIDs.

A diagram illustrating the format of a prior art multiple BSSID information element incorporating IE values of multiple BSSIDs is shown in FIG. 6. The multiple BSSID information element, generally referenced 100, comprises a 1-byte element ID field 102, 1-byte length field 104, 1-byte MAX BSSID indicator field 106 and a variable length non-transmitted BSSID profile field 108.

The value of the length field is the length of the Non-Transmitted BSSID profile, i.e. (variable)+1. More than one Multiple BSSID element may be included in a Beacon frame. The MAX BSSID Indicator field is ‘n’, where 2n is the maximum number of BSSIDs supported by the access point, including the transmitted BSSID. The actual number of SSIDs supported by the access point is not explicitly signaled.

The Non-Transmitted BSSID Profile field includes the Capabilities field followed by a variable number of information elements. Access Points supporting the IEEE 802.11v specification transmit the Multiple BSSID IE in Beacon and Probe Response messages. Stations supporting the IEEE 802.11v specification derive information on multiple security profiles from the Multiple BSSID ILEs received from the access point.

The advantages of this scheme include: (1) no protocol overhead required since stations receive all data on security profiles in a single packet; (2) it is a battery power efficient scheme; and (3) it is a roaming time efficient scheme. A major disadvantage of this method, however, is that it is not backward compatible with existing access point, since it will only work with 802.11v capable access points and stations.

Thus, there is a need for a mechanism that allows the stations in a WLAN to obtain knowledge of all possible security profiles that a particular access point supports. The scheme preferably does not suffer from the disadvantages of the prior art schemes described above. The scheme should be backward compatible with existing stations thereby eliminating the requirement to make any changes to existing deployed stations. In addition, it should minimize cost and its implementation should require minimal changes to access points.

### SUMMARY OF THE INVENTION

The present invention is a novel and useful apparatus for and method of advertising multiple security profiles in wireless local area networks (WLANs). The security profile advertisement mechanism of the present invention advertises all configured security profiles by sending unsolicited 802.11 management probe response frames to the broadcast MAC address for every available security profile. The access points sends these unsolicited probe response frames periodically, such as with the Beacon period. The conventional management application in the stations receives unsolicited advertisements of multiple SSIDs and perform a passive scanning process to obtain a list of BSSs available on the radio channel. The station can then display a list of all detected SSID advertisements to the user. The user of the station obtains information on all security profiles available on the access point without requiring any prior knowledge of specific SSIDs.

The security profile advertisement mechanism of the present invention allows the implementation of a WLAN network wherein stations obtain information on all available SSIDs that is interoperable with standard station implementations.

Although the mechanism of the present invention can be used in numerous types of communication systems, to aid in illustrating the principles of the present invention, the description of the security profile advertisement mechanism is provided in the context of a WLAN radio enabled communication device such as a cellular phone.

Although the security profile advertisement mechanism of the present invention can be incorporated in numerous types of WLAN enabled communication devices such access points, etc. it is also described in the context of a wireless communications device such as a cellular phone, multimedia player, PDA, smart phone, etc. It is appreciated, however, that the invention is not limited to the example applications presented, whereas one skilled in the art can apply the principles of the invention to other communication systems as well without departing from the scope of the invention.

The security profile advertisement mechanism has several advantages including: (1) full backward compatibility with existing WLAN stations as the mechanism does not require any changes to and is fully interoperable with existing stations; (2) the mechanism can be implemented in the access points entirely as a software/firmware upgrade thus enabling remote updating of exiting access devices over a network; (3) implementation requires little cost and does not required any hardware changes to access devices; (4) minimization of the number of probe request/response messages stations need to acquire SSID/security profile information, thus reducing air time and improving battery power consumption; (5) STA battery power efficient with no protocol overhead as probe response frames are transmitted at higher rates, thus reducing the total time STA receivers are switched on; (6) STA roaming time efficient since STAs receive all necessary information without protocol overhead; and (7) there is no impact on the quality of service over the air channel.

Note that some aspects of the invention described herein may be constructed as software objects that are executed in embedded devices as firmware, software objects that are executed as part of a software application on either an embedded or non-embedded computer system such as a digital signal processor (DSP), microcomputer, minicomputer, microprocessor, etc. running a real-time operating system such as WinCE, Symbian, OSE, Embedded LINUX, etc. or non-real time operating system such as Windows, UNIX, LINUX, etc., or as soft core realized HDL circuits embodied in an Application. Specific Integrated Circuit (ASIC) or Field Programmable Gate Array (FPGA), or as functionally equivalent discrete hardware components.

There is thus provided in accordance with the invention, a method of advertising security profiles in a wireless local area network (WLAN), the method comprising the steps of generating one or more unsolicited broadcast probe response frames, each unsolicited broadcast probe response frame incorporating security profile information corresponding to a security profile to be advertised and broadcasting the one or more unsolicited broadcast probe response frames to stations in the WLAN.

There is also provided in accordance with the invention, a method of advertising security profiles in a wireless local area network (WLAN) for use in an access point, the method comprising the step of periodically broadcasting a burst of unsolicited broadcast probe response frames wherein each frame in the burst comprises information corresponding to a security profile configuration in the access point.

There is further provided in accordance with the invention, a method of advertising security profiles in a wireless local area network (WLAN) for use in an access point, the method comprising the step of periodically broadcasting a burst of unsolicited broadcast probe response frames wherein each frame in the burst comprises information corresponding to a security profile configuration in the access point and broadcasting each frame burst at multiple transmission rates.

There is also provided in accordance with the invention, a single chip wireless local area network (WLAN) device comprising a PHY circuit operative to receive an IEEE 802.11 WLAN signal, a baseband processor/medium access control (MAC) coupled to the PHY circuit, a security profile advertisement module operative to periodically broadcast a burst of unsolicited broadcast probe response frames wherein each frame in the burst comprises information corresponding to a security profile configuration to be advertised and a host interface operative to interface the device to an external host.

There is further provided in accordance with the invention, a wireless local area network (WLAN) access point comprising a radio frequency (RF) front end module (FEM) compatible with IEEE 802.11 WLAN coupled to an antenna, a PHY circuit coupled to the RF FEM, a baseband processor/medium access control (MAC) coupled to the PHY circuit, a host coupled to the baseband processor/MAC and a security profile advertisement module operative to periodically broadcast a burst of unsolicited broadcast probe response frames wherein each frame in the burst comprises information corresponding to a security profile configuration to be advertised.

### BRIEF DESCRIPTION OF THE DRAWINGS

The invention is herein described, by way of example only, with reference to the accompanying drawings, wherein:

FIG. 1 is a network diagram illustrating an example prior art wireless LAN network;

FIG. 2 is a network diagram illustrating an example ad hoc IBSS wireless LAN network;

FIG. 3 is a prior art example of a WLAN with multiple SSID deployment;

FIG. 4 is a prior art example of a WLAN with multiple BSSID deployment;

FIG. 5 is a diagram illustrating the format of a prior art probe request multiple SSID information element;

FIG. 6 is a diagram illustrating the format of a prior art information element incorporating IE values of multiple BSSIDs;

FIG. 7 is a diagram illustrating an example WLAN with multiple BSSIS deployment incorporating the security profile advertisement mechanism of the present invention;

FIG. 8 is a diagram illustrating the format of a probe request frame;

FIG. 9 is a diagram illustrating the format of a probe response frame;

FIG. 10 is a diagram illustrating the format of the unsolicited broadcast probe response frame of the present invention;

FIG. 11 is a diagram illustrating an example unsolicited broadcast probe response frame burst of the present invention;

FIG. 12 is a flow diagram illustrating the security profile advertisement method of the present invention;

FIG. 13 is a block diagram illustrating an example access point incorporating the security profile advertisement module of the present invention;

FIG. 14 is a block diagram illustrating example access point hardware;

FIG. 15 is a block diagram illustrating the 802.11 subsystem of FIG. 14 in more detail;

FIG. 16 is a block diagram illustrating the 802.11 MAC/broadband/radio block of FIG. 14 in more detail;

FIG. 17 is a block diagram illustrating the access point software architecture in more detail; and

FIG. 18 is a simplified block diagram illustrating an example mobile communication device incorporating a WLAN STA.

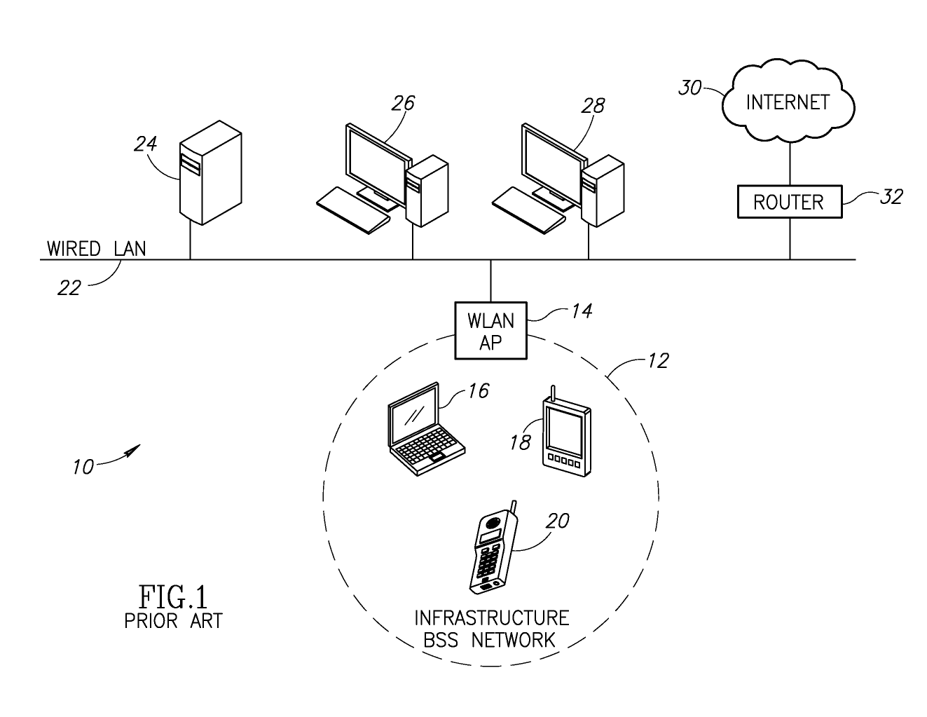

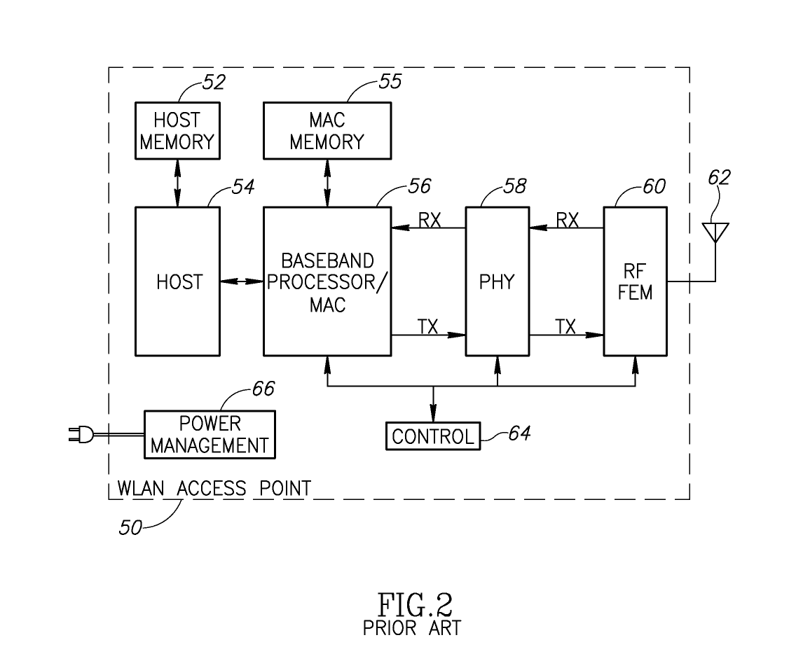

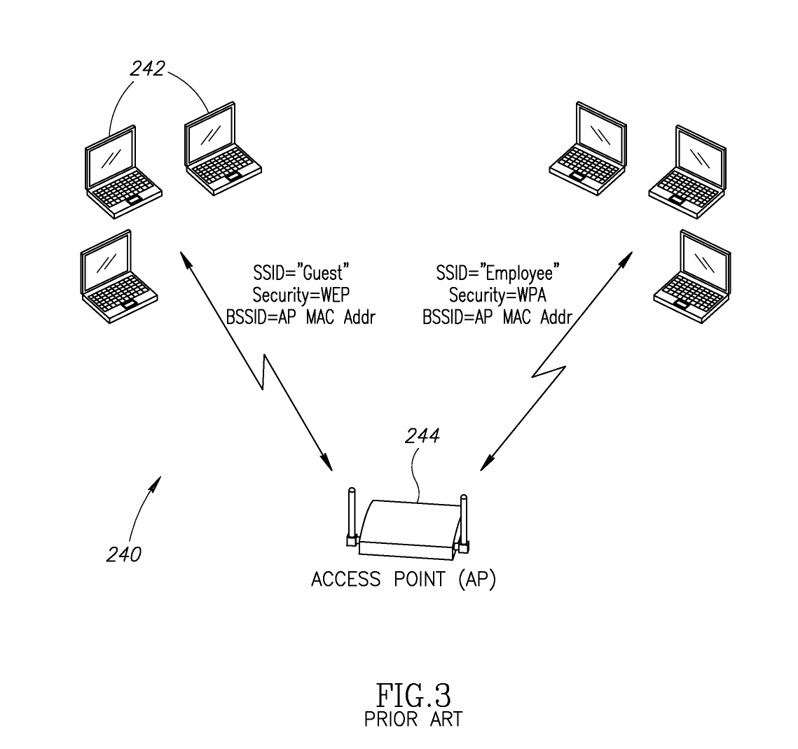

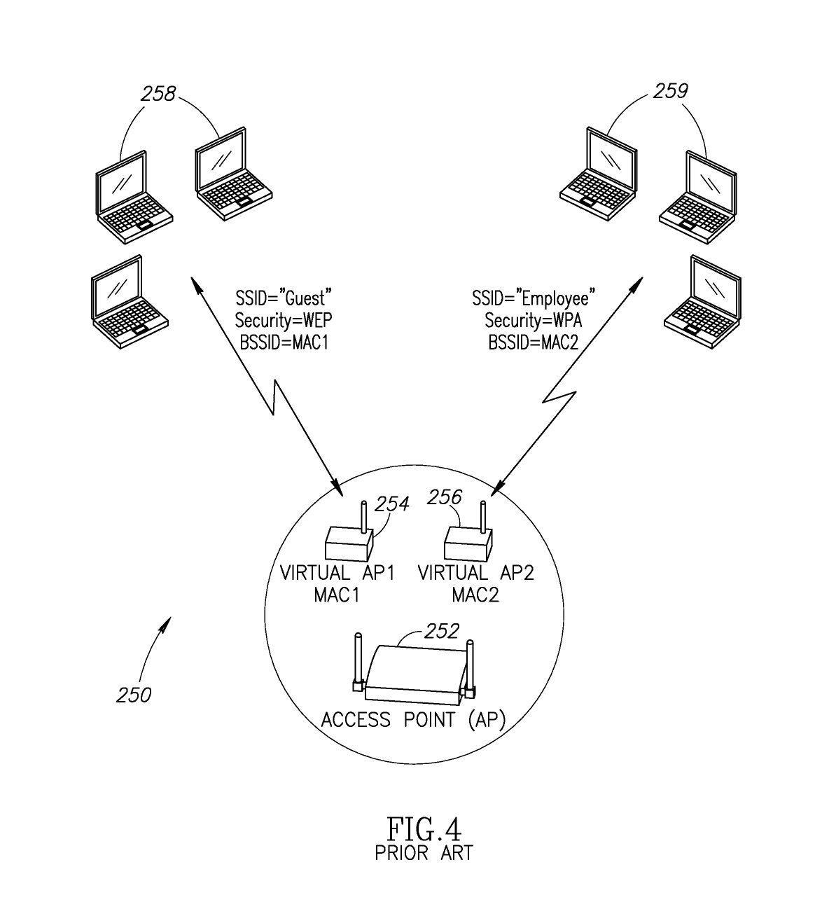

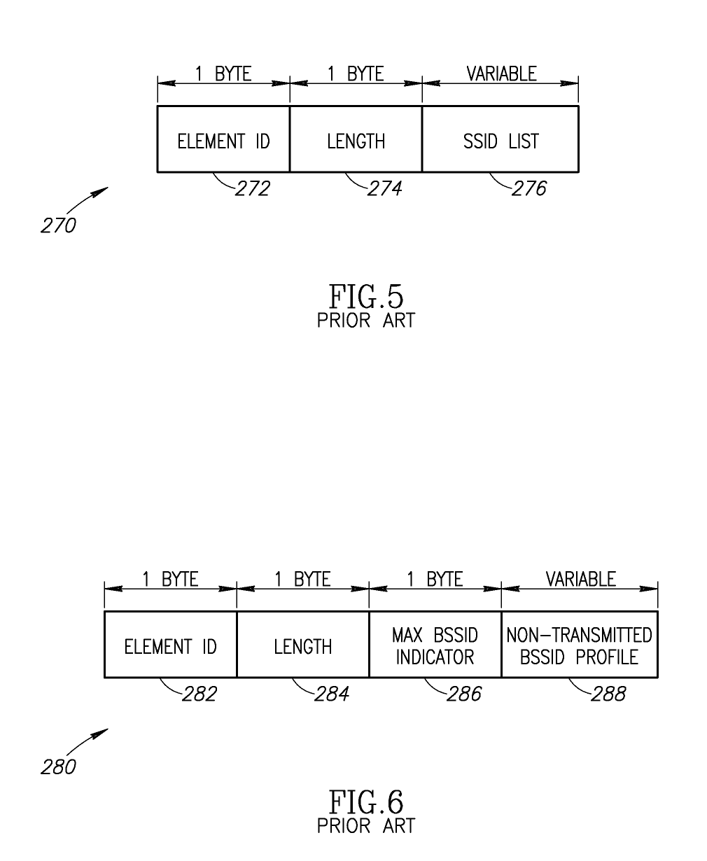

### DETAILED DESCRIPTION OF THE INVENTION

### Notation Used Throughout

The following notation is used throughout this document.

| Term | Definition |
|---|---|
| AC | Alternating Current |
| ADC | Analog to Digital Converter |
| AIFS | Arbitration Inter-Frame Space |
| AP | Access Point |
| API | Application Programming Interface |
| ASIC | Application Specific Integrated Circuit |
| ATIM | Announcement Traffic Indication Message |
| AVI | Audio Video Interleave |
| BMP | Windows Bitmap |
| BSS | Basic Service Set |
| CPU | Central Processing Unit |
| CRC | Cyclic Redundancy Code |
| CW | Contention Window |
| DAC | Digital to Analog Converter |
| DC | Direct Current |
| DSP | Digital Signal Processor |
| DSSS | Direct Sequence Spread Spectrum |
| EDGE | Enhanced Data rates for GSM Evolution |
| EEPROM | Electrically Erasable Programmable Read Only Memory |
| EPROM | Erasable Programmable Read Only Memory |
| ESS | Extended Service Set |
| FCS | Frame Check Sequence |
| FEM | Front End Module |
| FM | Frequency Modulation |
| FPGA | Field Programmable Gate Array |
| GPRS | General Packet Radio Service |
| GPS | Ground Positioning Satellite |
| GUI | Graphical User Interface |
| HDL | Hardware Description Language |
| I/F | Interface |
| IBSS | Independent Basic Service Set |
| ID | Identification |
| IE | Information Element |
| IEEE | Institute of Electrical and Electronics Engineers |
| IP | Internet Protocol |
| JPG | Joint Photographic Experts Group |
| LAN | Local Area Network |
| MAC | Media Access Control |
| MANET | Mobile Ad Hoc Network |
| MP3 | MPEG-1 Audio Layer 3 |
| MPG | Moving Picture Experts Group |
| NIC | Network Interface Card |
| NVM | Non-Volatile Memory |
| OFDM | Orthogonal Frequency Division Multiplexing |
| P2P | Peer to Peer |
| PC | Personal Computer |
| PCI | Personal Computer Interconnect |
| PDA | Portable Digital Assistant |
| RAM | Random Access Memory |
| RF | Radio Frequency |
| ROM | Read Only Memory |
| RSN-IE | Redundant Security Network Information Element |
| SIM | Subscriber Identity Module |
| SPI | Serial Peripheral Interface |
| SSID | Service Set Identifier |
| STA | Station |
| TBTT | Target Beacon Transmit Time |
| TCP | Transmission Control Protocol |
| TSF | Time Synchronization Function |
| TU | Time Unit |
| TV | Television |
| USB | Universal Serial Bus |
| UWB | Ultra Wideband |
| WiFi | Wireless Fidelity |
| WiMax | Worldwide Interoperability for Microwave Access |
| WiMedia | Radio platform for UWB |
| WLAN | Wireless Local Area Network |
| WMA | Windows Media Audio |
| WMV | Windows Media Video |

### DETAILED DESCRIPTION OF THE INVENTION

The present invention is a novel and useful apparatus for and method of advertising multiple security profiles in wireless local area networks (WLANs). The security profile advertisement scheme provides a mechanism to advertise multiple security profiles using Broadcast Probe Response messages that are sent periodically in an unsolicited manner by the access point. These messages (i.e. frames) are sent without the need for the STAs to send Probe Request messages beforehand.

Note that throughout this document, the term communications device is defined as any apparatus or mechanism adapted to transmit, receive or transmit and receive data through a medium. The term communications transceiver or communications device is defined as any apparatus or mechanism adapted to transmit and receive data through a medium. The communications device or communications transceiver may be adapted to communicate over any suitable medium, including wireless or wired media. Examples of wireless media include RF, infrared, optical, microwave, UWB, Bluetooth, WiMax, WiMedia, WiFi, or any other broadband medium, etc. Examples of wired media include twisted pair, coaxial, optical fiber, any wired interface (e.g., USB, Firewire, Ethernet, etc.). The term Ethernet network is defined as a network compatible with any of the IEEE 802.3 Ethernet standards, including but not limited to 100Base-T, 100Base-T or 1000Base-T over shielded or unshielded twisted pair wiring. The terms communications channel, link and cable are used interchangeably.

The term multimedia player or device is defined as any apparatus having a display screen and user input means that is capable of playing audio (e.g., MP3, WMA, etc.), video (AVI, MPG, WMV, etc.) and/or pictures (JPG, BMP, etc.). The user input means is typically formed of one or more manually operated switches, buttons, wheels or other user input means. Examples of multimedia devices include pocket sized personal digital assistants (PDAs), personal media player/recorders, cellular telephones, handheld devices, and the like.

The term security profile is intended to refer to a mechanism or method used to achieve privacy over a WLAN connection. Examples of a security profile include: No Privacy, Fixed WEP, 802.1X Authentication with Dynamic WEP, WPA and WPA2.

Some portions of the detailed descriptions which follow are presented in terms of procedures, logic blocks, processing, steps, and other symbolic representations of operations on data bits within a computer memory. These descriptions and representations are the means used by those skilled in the data processing arts to most effectively convey the substance of their work to others skilled in the art. A procedure, logic block, process, etc., is generally conceived to be a self-consistent sequence of steps or instructions leading to a desired result. The steps require physical manipulations of physical quantities. Usually, though not necessarily, these quantities take the form of electrical or magnetic signals capable of being stored, transferred, combined, compared and otherwise manipulated in a computer system. It has proven convenient at times, principally for reasons of common usage, to refer to these signals as bits, bytes, words, values, elements, symbols, characters, terms, numbers, or the like.

It should be born in mind that all of the above and similar terms are to be associated with the appropriate physical quantities they represent and are merely convenient labels applied to these quantities. Unless specifically stated otherwise as apparent from the following discussions, it is appreciated that throughout the present invention, discussions utilizing terms such as ‘processing,’ ‘computing,’ ‘calculating,’ ‘determining,’ ‘displaying’ or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

The invention can take the form of an entirely hardware embodiment, an entirely software embodiment or an embodiment containing a combination of hardware and software elements. In one embodiment, a portion of the mechanism of the invention is implemented in software, which includes but is not limited to firmware, resident software, object code, assembly code, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium is any apparatus that can contain, store, communicate, propagate, or transport the program for use by or in connection with the instruction execution system, apparatus, or device, e.g., floppy disks, removable hard drives, computer files comprising source code or object code, flash semiconductor memory (USB flash drives, etc.), ROM, EPROM, or other semiconductor memory devices.

### Security Profile Advertisement Mechanism

The security profile advertisement mechanism of the present invention advertises all configured security profiles by sending unsolicited 802.11 management probe response frames to the broadcast MAC address for every available security profile. The access points sends these unsolicited probe response frames periodically, such as with the Beacon period. The conventional management application in the stations receive unsolicited advertisements of multiple SSIDs and perform a passive scanning process to obtain a list of BSSs available on the radio channel. The station can then display a list of all detected SSID advertisements to the user. The user of the station obtains information on all security profiles available on the access point without requiring any prior knowledge of specific SSIDs.

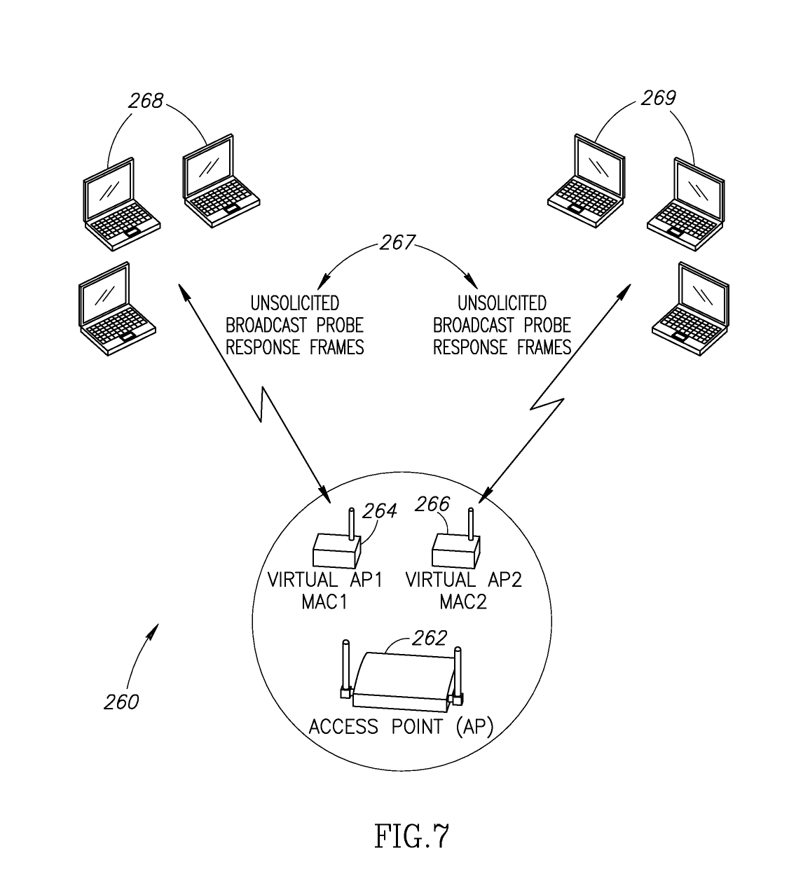

A diagram illustrating an example WLAN with multiple BSSID deployment incorporating the security profile advertisement mechanism of the present invention is shown in FIG. 7. The network, generally referenced 260, comprises an access point 262 that implements two virtual APs, virtual AP 1 (264) and virtual AP 2 (266) having MAC addresses MAC1 and MAC2, respectively. Virtual AP 1 is in communication with a plurality of STAs 268 with “guest” SSID while virtual AP 2 is in communication with a plurality of STAs 269 with “Employee” SSID. The security for each SSID is different, i.e. WEP and WPA. The BSSID of virtual AP 1 is MAC1 while the BSSID of virtual AP 2 is MAC2. When Virtual APs AP1 and AP2 have the same MAC Address MAC1 and corresponding single BSSID then Multiple SSID deployment takes place.

In accordance with the invention, the access point transmits unsolicited broadcast probe response frames 267 using the broadcast MAC address to all the STAs in the WLAN. The probe response frames comprise the SSID/security profile information of all the security profiles configured in the access point. The STAs process the probe response frames in accordance with the IEEE 802.11 specification without modification.

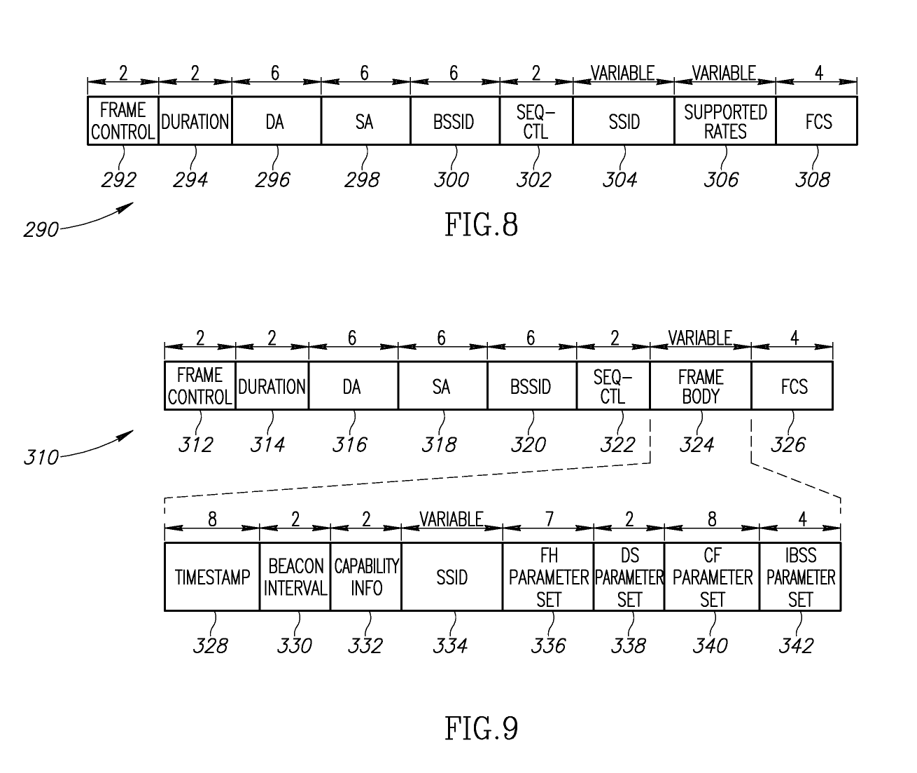

A diagram illustrating the format of a probe request frame is shown in FIG. 8. The probe request frame, generally referenced 290, comprises a 2-byte frame control field 292, 2-byte duration field 294, 6-byte destination address field 296, 6-byte source address field 298, 6-byte BSSID field 300, 2-byte SSEQ-CTL field 302, variable length SSID field 304, variable length supported rates field 306 and 4-byte frame check sequence (FCS).

A diagram illustrating the format of a probe response frame is shown in FIG. 9. The probe response frame, generally referenced 310, comprises a 2-byte frame control field 312, 2-byte duration field 304, 6-byte destination address field 316, 6-byte source address field 318, 6-byte BSSID field 320, 2-byte SSEQ-CTL field 322, variable length frame body 324 and 4-byte frame check sequence (FCS). The frame body 324 comprises an 8-byte timestamp field 328, 2-byte beacon interval field 330, 2-byte capability information field 332, variable length SSID field 334, 7-byte FH parameter set field 336, 2-byte DS parameter set field 338, 8-byte CF parameter set field 340 and 4-byte IBSS parameter set 342.

Note that 802.11 mobile stations use Probe Request frames to scan an area for existing 802.11 networks. A Probe Request frame comprises the SSID and the rates supported by the mobile station. Stations that receive Probe Requests use the information to determine whether the mobile station can join the network.

If a Probe Request encounters a network with compatible parameters, the network normally sends a Probe Response frame. The station that sent the last Beacon is responsible for responding to incoming probes. In infrastructure networks, this station is the access point. The Probe Response frame includes all the parameters in a Beacon frame, which enables mobile stations to match parameters and join the network.

In accordance with the invention, STAs are informed of the available SSIDs by the advertisement of security profiles by the access point. Multiple security profiles are advertised by the access point using what are referred to as unsolicited broadcast probe response frames.

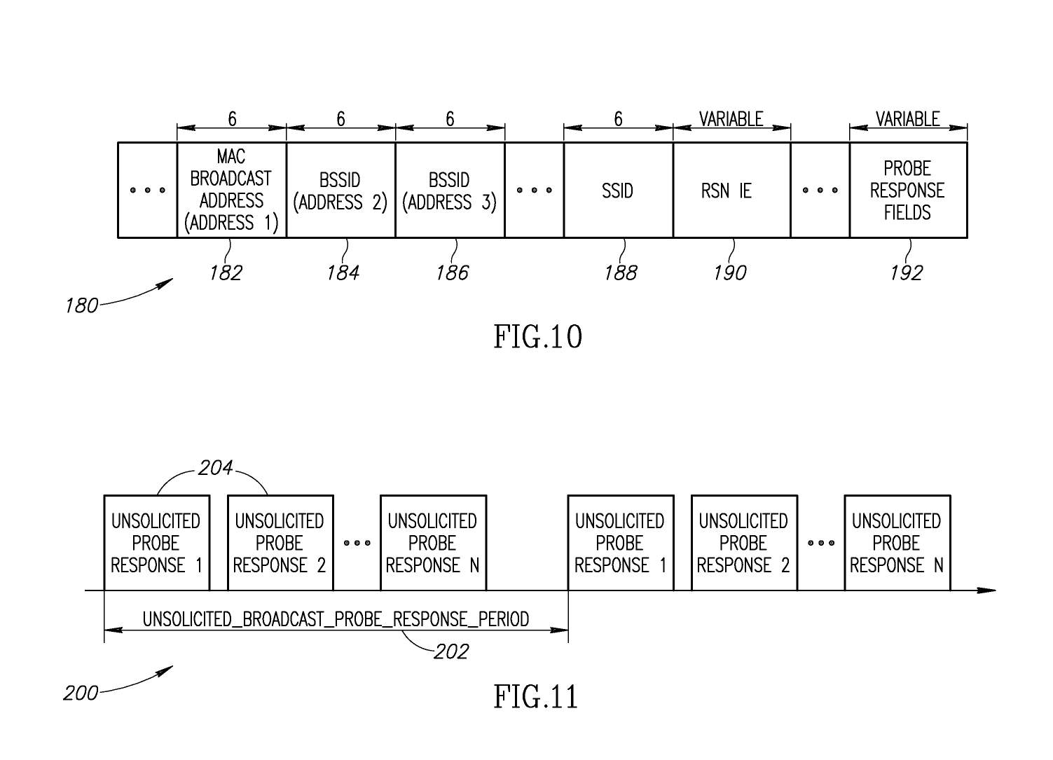

A diagram illustrating the format of the unsolicited broadcast probe response frame of the present invention is shown in FIG. 10. Each unsolicited broadcast probe response frame, generally referenced 180, is transmitted with the following information: a 6-byte MAC broadcast address 182 (address #1) (i.e. FF:FF:FF:FF:FF:FF), 6-byte BSSID of the Access Point corresponding to a specific Security Profile or single BSSID in case of multiple SSIDs 184 (address #2), 6-byte BSSID of the Access Point corresponding to a specific Security Profile or single BSSID in case of multiple SSIDs 186 (address #3), 6-byte SSID corresponding to a particular SSID/security profile 188, variable length Redundant Security Network Information Element (RSN IE) corresponding to a particular SSID/security profile 190 and the fields common to all Probe Response frames 192.

In accordance with the mechanism of the invention, the access point periodically transmits a burst of Probe Response frames to the Broadcast MAC address. One probe response message is broadcast for each security profile configured in the access point. Unsolicited Probe Response frames are sent with AC_BE configured, i.e. best effort channel access parameters.

Note that the burst of unsolicited broadcast Probe Response frames may be sent using any pattern, e.g., once, repeatedly, periodically, etc. Typically, they are transmitted with a certain periodicity, e.g., with period UNSOLICITED_BROADCAST_PROBE_RESPONSE_PERIOD. Note that for example, the UNSOLICITED_BROADCAST_PROBE_RESPONSE_PERIOD may be configured in the range of 10 to 1000 milliseconds, with a default value of 100 milliseconds.

A timing diagram illustrating an example unsolicited broadcast probe response frame burst of the present invention is shown in FIG. 11. The bursts, generally referenced 200, comprise a plurality of unsolicited broadcast probe response frames 204. Two complete bursts are shown for example purposes only. Each burst period 202, the access point transmits unsolicited broadcast probe response frames 1 through N corresponding to security profiles 1 to N to be advertised that are sent in the burst. The burst transmission is repeated with period UNSOLICITED_BROADCAST_PROBE_RESPONSE_PERIOD.

In order to reduce the transmit time for the sending of the burst from the access point to the STAs, the mechanism of the invention provides the capability to vary the rate of transmission. Thus, in operation, the same burst is transmitted a plurality of times, each with at a different transmission rate.

The burst of unsolicited broadcast probe response frames are sent with varying transmit rates in order to reduce overall transmission time and therefore reduce the battery consumption of STAs receiving the unsolicited probe response frames.

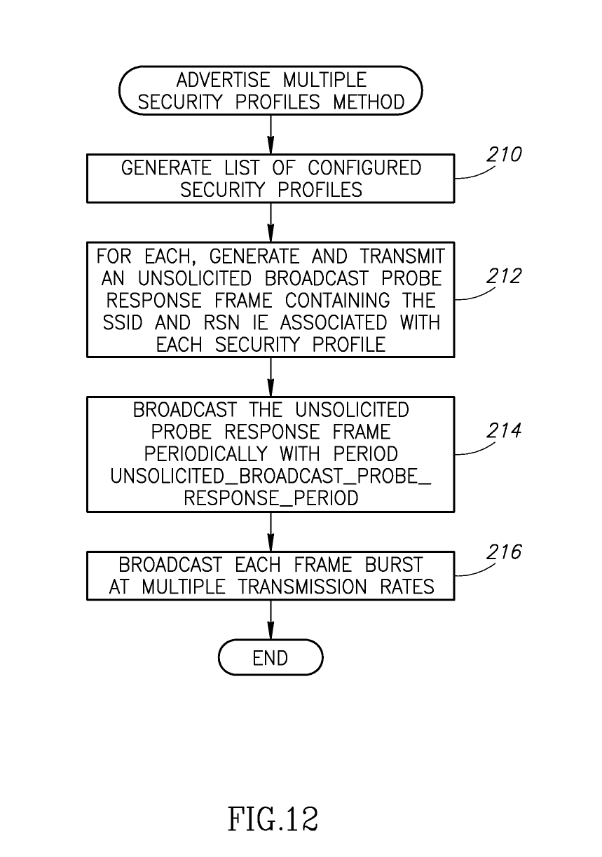

The following method illustrates both the advertisement and the multiple transmission rate mechanism of the invention. A flow diagram illustrating the security profile advertisement method of the present invention is shown in FIG. 12. This method is typically implemented in the access point. Initially, a list of configured security profiles/SSIDs to be advertised is generated (step 210). For each security profile/SSID, the access point generates and transmits an unsolicited broadcast probe response frame containing the SSID and RSN IE associated with each security profile (step 212). The probe response frames are sent as a burst. The unsolicited broadcast probe response frame burst is then periodically transmitted using the MAC broadcast address and with a period of UNSOLICITED_BROADCAST_PROBE_RESPONSE_PERIOD (step 214). Optionally, the frame burst is repeatedly sent at multiple transmission rates as defined in the entity UNSOLICITED_PROBE_RESPONSE_TX_RATE_SET (step 216).

Thus, for example, three different transmission rates of 1 Mbps, 11 Mbps, 24 Mbps are used. STAs that are close to the transmitter will receive all three transmissions, while STAs that are at the outskirts of the BSS will only receive the slower transmission, since they are too far away to reliably receive the faster transmission.

A pseudo code listing of an example algorithm to set the transmit rate for a burst of unsolicited probe response frames is presented below in Listing 1.

Listing 1: Multiple Frame Burst Transmit Rates

```
Define a set of PHY transmit rates in
UNSOLICITED_PROBE_RESPONSE_TX_RATE_SET;
* A default value for
* UNSOLICITED_PROBE_RESPONSE_TX_RATE_SET
is an array of three elements: 1 Mbps, 11 Mbps, 24 Mbps.
set i to 1;
    while unsolicited broadcast probe response transmission is enabled
      do:
          transmit unsolicited broadcast probe response frame burst at
          UNSOLICITED_PROBE_RESPONSE_TX_RATE_SET[i]
          PHY rate;
          increment i;
          if i > 3 then set i to 1
      end do
    end while
```

A major benefit of transmitting the frame burst at multiple rates is that it improves the efficiency of STA battery power with no extra protocol overhead required as probe response frames are transmitted at higher rates, thereby reducing the total time STA receivers are switched on.

It is important to note that the behavior of the STAs after receiving the unsolicited broadcast probe response is as per the IEEE 802.11 specification. STAs that receive multiple frame bursts, only need to fully process one as the others can be ignored. For example, a STA near the transmitter will receive three frame burst transmissions at each of the three rates 1, 11, 24 Mbps. Once a frame burst is successfully received and decoded, the other bursts can be ignored.

### Example WLAN Access Point

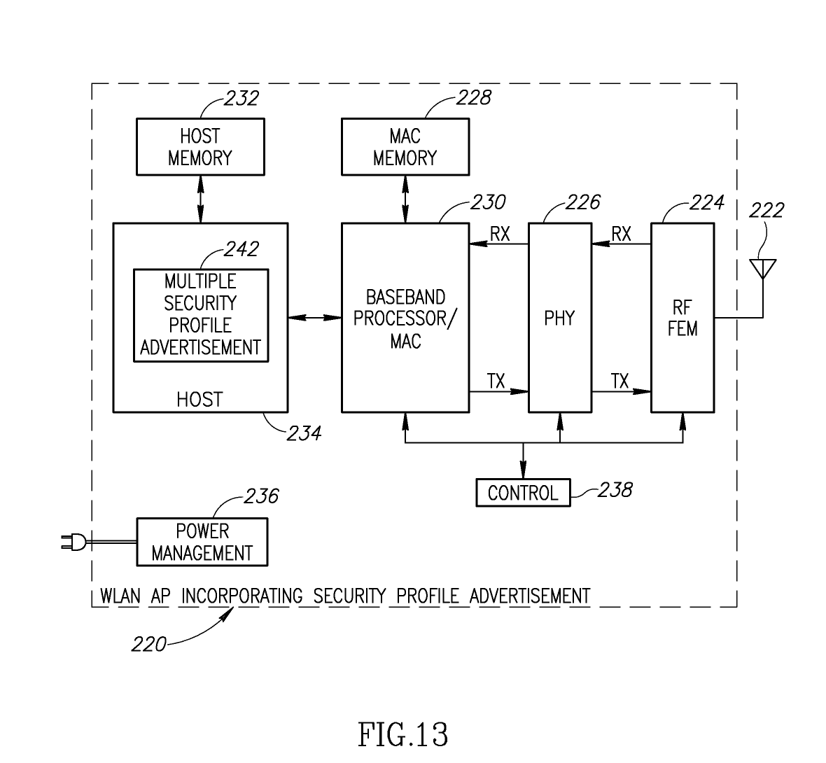

A block diagram illustrating an example access point incorporating the security profile advertisement module of the present invention is shown in FIG. 13. The WLAN access point, generally referenced 220, comprises an RF front end module (FEM) 224 coupled to antenna 222, PHY circuit 226, baseband processor/MAC 230, host 234, MAC memory 228, host memory 232, controller 238 and power management 236. The RF FEM comprises the RF switch, bandpass filter, bandpass filter and other RF front end circuitry (not shown). The PHY circuit comprises I and Q signal analog to digital converters (ADCs) and I and Q signal digital to analog converters (DACs) (not shown). MAC and host memories 228, 232 comprise any suitable memory devices such as EEPROM, static RAM, ROM, FLASH memory, other non-volatile memory (NVM), etc. Note that in one embodiment, the mechanism of the invention is implemented as firmware/software that resides in memory 228 and/or 232 and executes on the host processor 234 or other computing resource (e.g., controller 238).

In this example, the host implements the multiple security profile advertisement mechanism (block 242) of the present invention. Note that the mechanism can be implemented entirely on the MAC, entirely on the host or partially in both, depending on the particular implementation without departing from the scope of the invention. Note that software and/or firmware operative to implement the mechanism of the invention can reside in whole or in part in memories 232, 228.

The RF front end circuit with the radio functions to filter and amplify RF signals and perform RF to IF conversion to generate I and Q data signals for the ADCs and DACs in the PHY. The baseband processor functions to modulate and demodulate I and Q data, perform carrier sensing, transmission and receiving of frames. The medium access controller (MAC) functions to control the communications (i.e. access) between the host device and applications. The power management circuit 236 is adapted to receive power via a wall adapter, battery or other power source, e.g., from the host interface (if any). The host interface may comprise PCI, CardBus or USB interfaces.

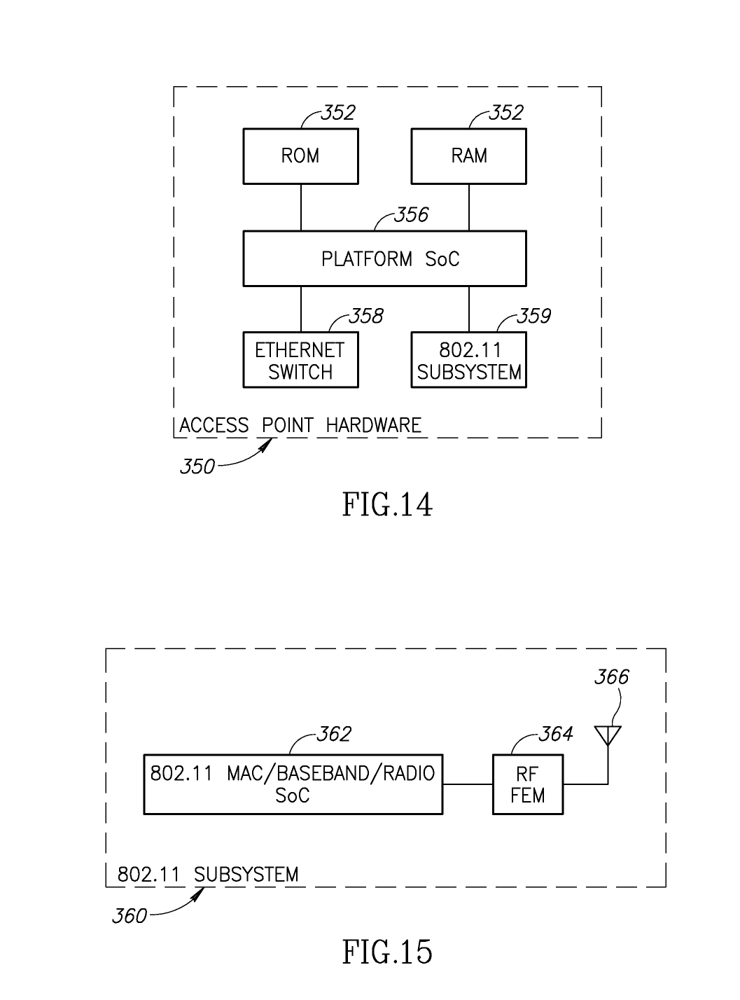

A block diagram illustrating example access point hardware is shown in FIG. 14. The access point, generally referenced 350, comprises a platform system on chip (SoC) core 356 coupled to ROM (i.e. FLASH) 352 and RAM 354, Ethernet switch 358 and 802.11 subsystem 359. The WLAN access point is a system that provides connectivity for IEEE 802.11 clients (i.e. STAs) to the wired network infrastructure (i.e. the Internet).

The platform SoC 356 comprises a generic CPU (e.g., ARM11, etc.), external memory controller, interrupt controller and I/O ports (e.g., UART, etc.). The platform SoC is operative to execute access point firmware stored in ROM (i.e. FLASH) and RAM. Connectivity from the access point to the wired infrastructure is enabled by the Ethernet switch 358. The 802.11 subsystem 359 provides the 802.11 access point interface.

A block diagram illustrating the 802.11 subsystem of FIG. 14 in more detail is shown in FIG. 15. The 802.11 subsystem, generally referenced 360, comprises an RF FEM 364 coupled to antenna 366 and the 802.11 MAC/baseband/radio SoC 362.

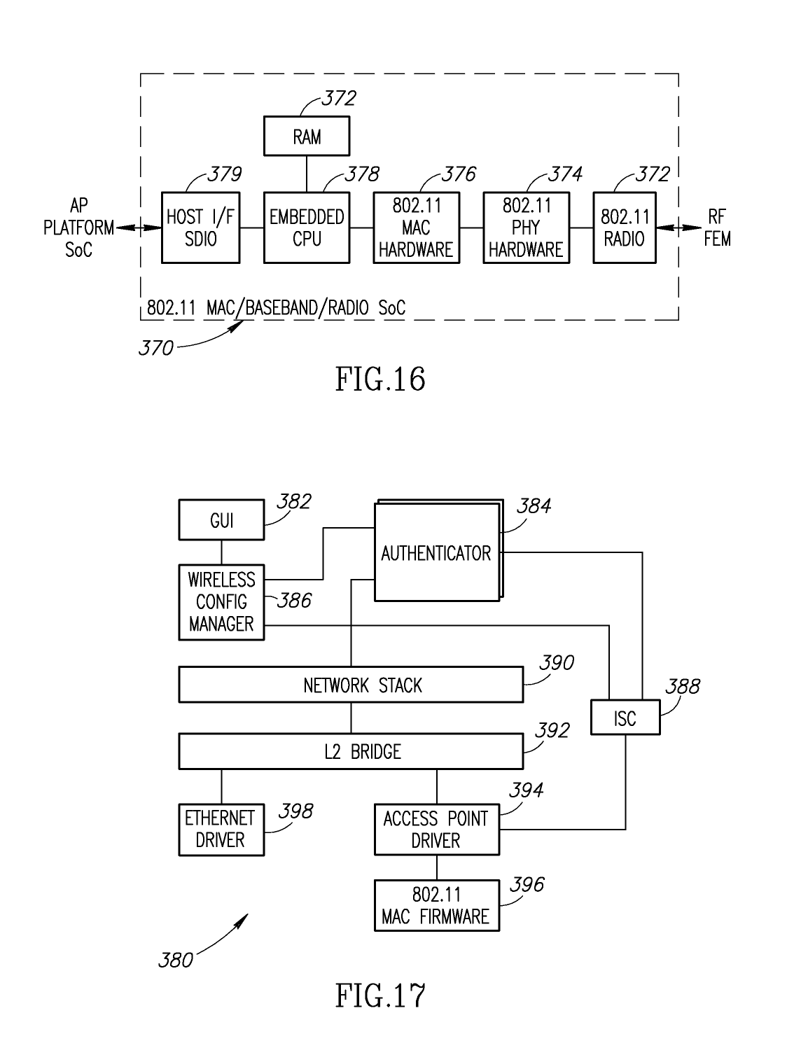

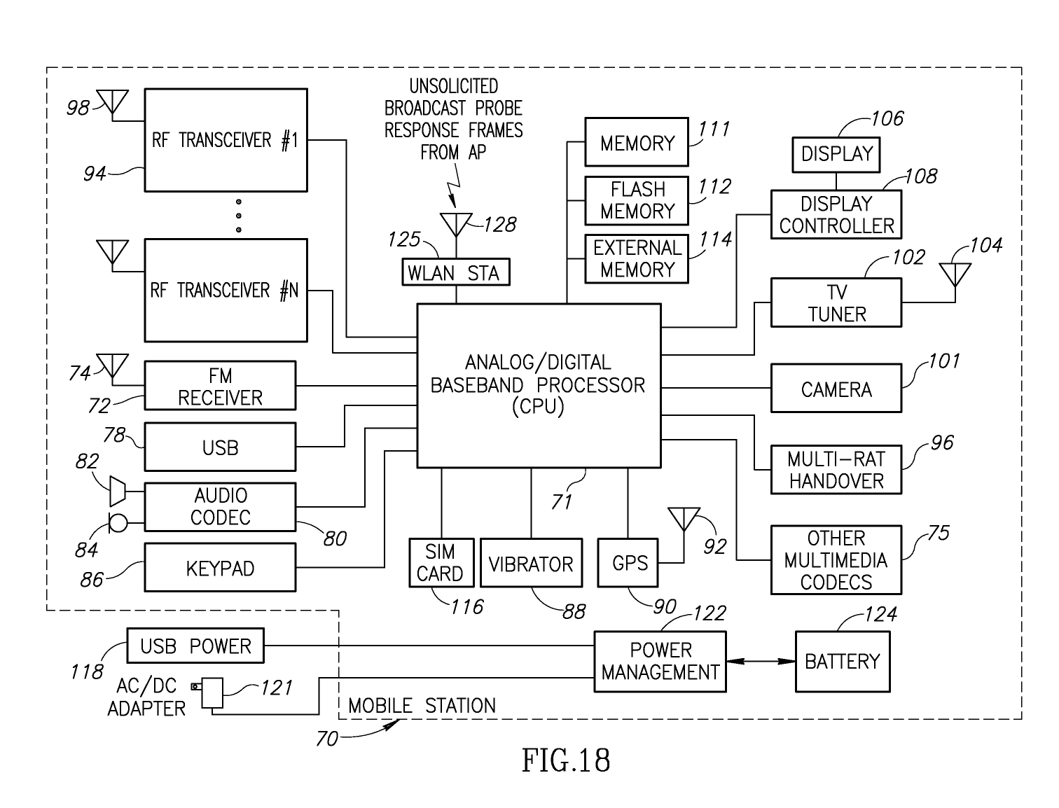

A block diagram illustrating the 802.11 MAC/broadband/radio block of FIG. 14 in more detail is shown in FIG. 16. The 802.11 MAC/baseband/radio SOC, generally referenced 370, comprises an embedded CPU 378 (e.g., ARM7, etc.), RAM 372, 802.11 MAC hardware 376, 802.11 PHY hardware 374, 802.11 radio hardware 372 and interfaces, including, a host interface 379 towards the access point platform SOC; RF front end interface towards RF front end and a UART debug interface (not shown).

The embedded CPU 378 is operative to execute firmware program code stored in the RAM 372. The program implements 802.11 MAC functionality that is not time critical (i.e. greater than 10 microsecond operation latency). The 802.11 MAC hardware 376 implements 802.11 MAC time critical functionality (i.e. less than 10 microsecond operation latency). The 802.11 PHY hardware 374 implements 802.11 PHY layer functionality. The 802.11 radio 372 implements the 802.11 radio functionality. The host interface 379 implements a suitable host interface protocol, such as Secure Digital Input/Output (SDIO).

A block diagram illustrating the access point software architecture in more detail is shown in FIG. 17. The components of the software architecture, generally referenced 380, comprises a GUI 382, wireless configuration manager 386, authenticator 384, network stack 390, L2 bridge 392, Inter Space Communication (ISC) block 388, access point driver 394, 802.11 MAC firmware 396 and Ethernet driver 398.

The wireless configuration manager 386 is operative to configure the various parameters of the access point. Specifically the wireless configuration manager configures multiple security profiles. The authenticator 384 is operative to establish and maintain one or more secured connections with stations belonging to the single security profile.

The access point driver 394 is operative to (1) establish and maintain an association of the station to a required SSID; (2) distribute encryption keys; and (3) convert MAC Service Data Units (MSDUs) received on a specific SSID to 802.1q packets with VLAN tag value corresponding to the particular SSID.

The 802.11 firmware 396 is operative to execute low-level non-time critical MAC functions. Specifically, the 802.11 firmware is responsible for sending probe response frames. Inter Space Communication (ISC) 388 is operative to implement a configuration interface between the access point driver 394, authenticator 384 and wireless configuration manager 386. The Ethernet driver is operative to implement the Ethernet driver. The L2 bridge 392 implements the Layer2 Bridge and forwards traffic between the Ethernet interface and the WLAN access point interface. The Network stack 390 implements TCP/IP Network stack.

The 802.11 firmware is incorporated in the 802.11 subsystem hardware component 359 (FIG. 14) and executed by the embedded CPU 378 (FIG. 16). The remainder of the software components are located in the platform RAM 354 and ROM 352 and executed by the platform SOC hardware component 356.

Multiple security profiles are created in accordance with the invention by the wireless configuration manager 386 based on user input and are configured to authenticator 384 and AP driver 394.

The access point driver 394 is operative to establish and maintain an association of a STA to a required SSID. It also creates broadcast probe response templates, one template per profile. The access point driver configures the following parameters to the 802.11 MAC firmware: (1) broadcast probe response templates; (2) UNSOLICITED_BROADCAST_PROBE_RESPONSE_PERIOD; and (3) UNSOLICITED_PROBE_RESPONSE_TX_RATE_SET.

The access point driver 394 enables the feature in 802.11 MAC firmware. The 802.11 MAC firmware 396 implements following functions: (1) the sending of configured broadcast probe response templates with period UNSOLICITED_BROADCAST_PROBE_RESPONSE_PERIOD; and (2) setting 802.11 PHY rates from UNSOLICITED_PROBE_RESPONSE_TX_RATE_SET in accordance with the unsolicited probe response transmit rate algorithm described supra.

### Example Mobile Device Incorporating WLAN

A simplified block diagram illustrating an example mobile communication device incorporating a WLAN STA is shown in FIG. 14. Note that the mobile device may comprise any suitable wired or wireless device such as multimedia player, mobile communication device, cellular phone, smartphone, PDA, Bluetooth device, etc. For illustration purposes only, the device is shown as a mobile device, such as a cellular phone. Note that this example is not intended to limit the scope of the invention.

The mobile device, generally referenced 70, comprises a baseband processor or CPU 71 having analog and digital portions. The mobile device may comprise a plurality of RF transceivers 94 and associated antennas 98. RF transceivers for the basic cellular link and any number of other wireless standards and Radio Access Technologies (RATs) may be included. Examples include, but are not limited to, Global System for Mobile Communication (GSM)/GPRS/EDGE 3G; CDMA; WiMAX for providing WiMAX wireless connectivity when within the range of a WiMAX wireless network; Bluetooth for providing Bluetooth wireless connectivity when within the range of a Bluetooth wireless network; WLAN for providing wireless connectivity when in a hot spot or within the range of an ad hoc, infrastructure or mesh based wireless LAN network; near field communications; UWB; etc. One or more of the RF transceivers may comprise additional antennas to provide antenna diversity which yields improved radio performance. The mobile device may also comprise internal RAM and ROM memory 110, Flash memory 112 and external memory 114.

The mobile device comprises a WLAN STA module 125 coupled to antenna 128. The WLAN STA implements a conventional STA as specified in the IEEE 802.11 standard and is operative to receive the unsolicited broadcast probe response frames from the access point, as described in more detail supra.

Several user-interface devices include microphone(s) 84, speaker(s) 82 and associated audio codec 80 or other multimedia codecs 75, a keypad for entering dialing digits 86 and for other controls and inputs, vibrator 88 for alerting a user, camera and related circuitry 100, a TV tuner 102 and associated antenna 104, display(s) 106 and associated display controller 108 and GPS receiver 90 and associated antenna 92. A USB or other interface connection 78 (e.g., SPI, SDIO, PCI, etc.) provides a serial link to a user's PC or other device. An FM transceiver 72 and antenna 74 provide the user the ability to listen to FM broadcasts as well as the ability to transmit audio over an unused FM station at low power, such as for playback over a car or home stereo system having an FM receiver. SIM card 116 provides the interface to a user's SIM card for storing user data such as address book entries, user identification, etc.

Portable power is provided by the battery 124 coupled to power management circuitry 122. External power may be provided via USB power 118 or an AC/DC adapter 121 connected to the battery management circuitry 122, which is operative to manage the charging and discharging of the battery 124.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. As numerous modifications and changes will readily occur to those skilled in the art, it is intended that the invention not be limited to the limited number of embodiments described herein. Accordingly, it will be appreciated that all suitable variations, modifications and equivalents may be resorted to, falling within the spirit and scope of the present invention. The embodiments were chosen and described in order to best explain the principles of the invention and the practical application, and to enable others of ordinary skill in the art to understand the invention for various embodiments with various modifications as are suited to the particular use contemplated.

What is claimed is:

1. A method of advertising security profiles in a wireless local area network (WLAN), said method comprising the steps of:
generating one or more unsolicited broadcast probe response frames, each unsolicited broadcast probe response frame incorporating security profile information corresponding to a security profile to be advertised; and
broadcasting said one or more unsolicited broadcast probe response frames to stations in said WLAN.

2. The method according to claim 1, wherein said one or more unsolicited broadcast probe response frames are sent in bursts, each frame within said burst incorporating a different security profile to be advertised.

3. The method according to claim 1, wherein said one or more unsolicited broadcast probe response frames are broadcast periodically.

4. The method according to claim 3, wherein said one or more unsolicited broadcast probe response frames are broadcast with a periodicity ranging from 10 to 1000 milliseconds.

5. The method according to claim 1, wherein each broadcast frame comprises a Basic Service Set Identifier (BSSID) of an access point corresponding to a specific security profile.

6. The method according to claim 1, wherein each broadcast frame comprises a Service Set Identifier (SSID) corresponding to a specific security profile.

7. The method according to claim 1, wherein each broadcast frame comprises a robust security network information element (RSN IE).

8. The method according to claim 1, further comprising the step of broadcasting said frames at different transmission rates.

9. The method according to claim 1, further comprising the step of broadcasting said frames at transmission rates of 1, 11 and 24 Mbps.

10. The method according to claim 1, wherein said method is implemented in a WLAN access point.

11. A method of advertising security profiles in a wireless local area network (WLAN) for use in an access point, said method comprising the step of:
periodically broadcasting a burst of unsolicited broadcast probe response frames wherein each frame in said burst comprises information corresponding to a security profile configuration in said access point.

12. The method according to claim 11, wherein said burst is transmitted with best effort channel access.

13. The method according to claim 11, wherein said burst is broadcast with a periodicity ranging from 10 to 1000 milliseconds.

14. The method according to claim 11, further comprising the step of broadcasting said frames at different transmission rates.

15. The method according to claim 11, further comprising the step of broadcasting said frames at transmission rates of 1, 11 and 24 Mbps.

16. A method of advertising security profiles in a wireless local area network (WLAN) for use in an access point, said method comprising the step of:
periodically broadcasting a burst of unsolicited broadcast probe response frames wherein each frame in said burst comprises information corresponding to a security profile configuration in said access point; and
broadcasting each frame burst at multiple transmission rates.

17. The method according to claim 16, wherein each frame burst is broadcast at transmission rates of 1, 11 and 24 Mbps.

18. The method according to claim 16, wherein each frame burst is transmitted with best effort channel access.

19. A single chip wireless local area network (WLAN) device, comprising:
a PHY circuit operative to receive an IEEE 802.11 WLAN signal;
a baseband processor/medium access control (MAC) coupled to said PHY circuit;
a security profile advertisement module operative to periodically broadcast a burst of unsolicited broadcast probe response frames wherein each frame in said burst comprises information corresponding to a security profile configuration to be advertised; and
a host interface operative to interface said device to an external host.

20. The device according to claim 19, wherein said security profile advertisement module is operative to broadcast said frames at different transmission rates.

21. The device according to claim 19, wherein said security profile advertisement module is operative to broadcast said frames at transmission rates of 1, 11 and 24 Mbps.

22. The device according to claim 19, wherein each frame burst is transmitted with best effort channel access.

23. The device according to claim 19, wherein said security profile advertisement module is implemented in baseband processor firmware.

24. A wireless local area network (WLAN) access point, comprising:
a radio frequency (RF) front end module (FEM) compatible with IEEE 802.11 WLAN coupled to an antenna;
a PHY circuit coupled to said RF FEM;
a baseband processor/medium access control (MAC) coupled to said PHY circuit;
a host coupled to said baseband processor/MAC; and
a security profile advertisement module operative to periodically broadcast a burst of unsolicited broadcast probe response frames wherein each frame in said burst comprises information corresponding to a security profile configuration to be advertised.

25. The access point according to claim 24, wherein said security profile advertisement module is operative to broadcast said frames at different transmission rates.

26. The access point according to claim 24, wherein said security profile advertisement module is operative to broadcast said frames at transmission rates of 1, 11 and 24 Mbps.

27. The access point according to claim 24, wherein each frame burst is transmitted with best effort channel access.

28. The access point according to claim 24, wherein said security profile advertisement module is implemented on said baseband processor, said host or a combination thereof.
